(19) United States
(12) Patent Application Publication
(10) Pub. No.: US 2003/0106606 A1
(43) Pub. Date: Jun. 12, 2003

(54) Filling valve of bottling plant

(76) Inventor: Gabriele Stocchi, Parma (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/312,875

(22) PCT Filed: Jul. 5, 2001
(86) PCT No.: PCT/IB01/00970

(30) Foreign Application Priority Data
Jul. 7, 2000 (IT) BO2000A000409

(51) Int. Cl. B65B 57/14; B65B 57/06; B65B 3/28; B67C 3/00; B65B 1/30

(52) U.S. Cl. 141/198

(57) ABSTRACT

Improvements to filling valves of bottling plants in which the interruption of the processing fluids' flow happens automatically when the level of the liquid inside the filled bottle reaches the lower edge of the vent tube and the air trapped in the filling valve prevents the coming out of the liquid from the tank even if the external membrane (6) is still in the open position.

### FIELD OF THE ART

The present invention is related to the technologies of the bottling processes, and it specifically pertains to improved filling valves of turret filling machines. Such technologies are included in the International Classification B67c.

### STATE OF THE ART

In the previous technology are known several kinds of filling valves that are set up peripherally around filling turrets.

All kinds of known filling valves have intercepting organs inside the bodies of the filling valve that constitute an obstacle for the flow of the filling fluid and for the cleansing options. In fact, said intercepting organs inside the downflow conduits create retention zones or interstices, where the residual particles of the processing fluid often are gathered.

The problem to be solved is to eliminate such intercepting organs inside the filling valve in order to eliminate all the related problems of the traditional filling valves.

### DESCRIPTION

The invention is now disclosed with reference to the schematic figures of the attached drawings as a not limiting example.

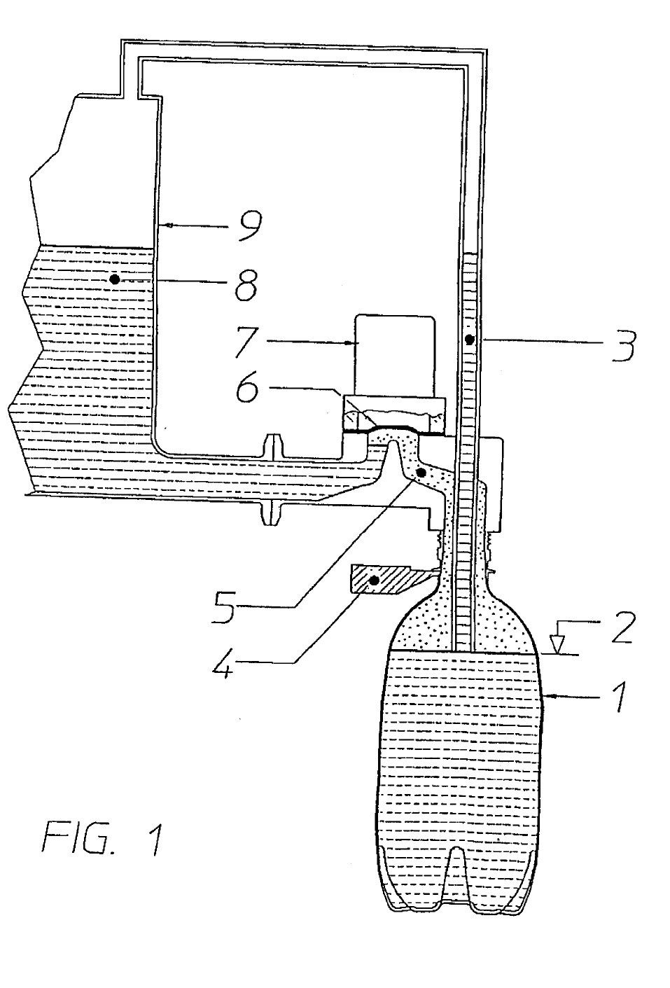

FIG. 1 represents schematically a filling valve at the end of filling phase of a bottle. One can notice that the filling valve does not have intercepting organs inside of the downflow conduits. Nonetheless, the downflow of the liquid is stopped by the air trapped inside the filling valve.

This phenomenon allows the optimization of the shape of the downflow conduits, thus solving all the problems of the traditional filing valves.

The filling valves made according the improvements object of the present invention will be cheaper in the realization and more reliable during the filling and cleansing operations.

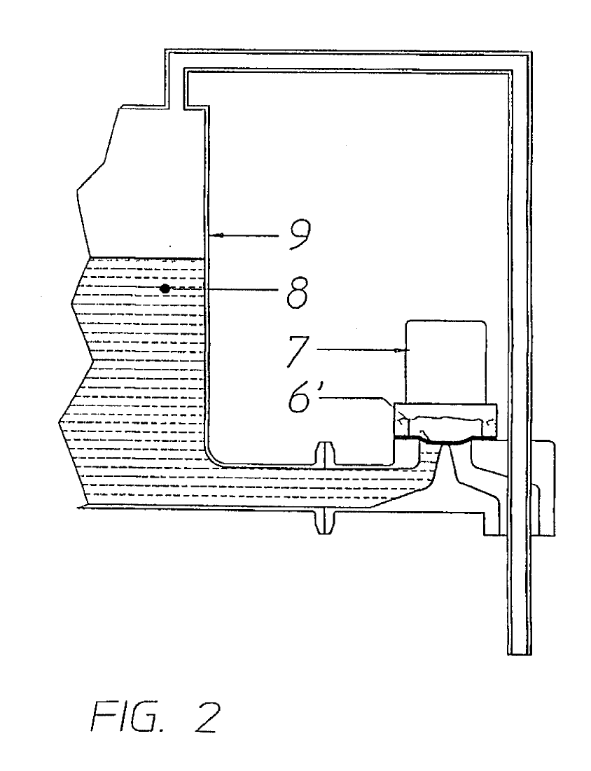

FIG. 2 represents schematically a filling valve during the removal phase of the filled bottle. One can notice that, during this phase, the filling valve without inner intercepting organs is closed by a membrane 6′ external to the enbloc body of the filling valve; said membrane is deformed by an external synchronized electrovalve 7.

One can notice that there are not intercepting and sealing organs inside the filling valve and that said membrane 6′, hermetically sealed, is constantly held upon the enbloc body of the filling valve and that it keeps closed from the outside the downflow conduit.

In the figures of the attached drawings, each single detail is marked as follows:

1 is the filled bottle

2 indicates the lower edge of the venting tube that sets the filling level of the liquid in the bottle

3 is the air venting tube inside the empty bottle

4 bottle's handling device

5 is the zone where the air is tapped when the liquid's level reaches the lower edge of the venting tube

6 is the external membrane in opening position

6′ is the external membrane in closing position

7 is the external synchronized electro-valve

8 is the liquid phase of the bottling process

9 is the general tank of the liquid

The evidence of the figures highlights the operation of the filling valve is extremely simple and automatic. In fact, even though the filling valve does not internal intercepting organs, the stopping of the filling process happens by siphon effect. It is the residual air that being trapped inside the flowing conduits interrupts the downflow of the liquid when inside the bottle is reached the level set by the position of the lower edge of the venting tube.

The absence of intercepting organs inside the filling valve allows to realize flowing conduits with optimized profile, that is without retention zones and interstices that disturb the laminar motion of the filling and don't obstruct the cleansing operation.

The invention of course allows for several variations of practical realization as far as the proportional structuring and the technological choice are concerned, that will adjusted to the different needs of bottling plants.

It is therefore evident that all improvements to filling valves that will be based on the inventive principles of the present invention, as substantially described, illustrated and hereinafter claimed, will be considered part of the protection sphere of the present invention.

1) Improvements to filling valves of bottling plants CHARACTERIZED BY THE FACT THAT the interception of the downflow of the process fluids happens automatically when the level of the liquid inside the filled bottle reaches the lower edge of the venting tube and that the air trapped inside the filling valve prevents the coming out of the liquid from the tank even if the external membrane 6 is still in the opening position.

2) Improvements to filling valves of bottling plants, as in claim 1, CHARACTERIZED BY THE FACT THAT since the internal organs of interception and sealing have been eliminated, the shape of downflow conduit is optimized because it does not present retention zones or interstices that disturb the laminar filling downflow and obstruct the cleansing operations of the bottling plant.

3) Improvements to filling valves of bottling plants, as in previous claims, CHARACTERIZED BY THE FACT THAT during the removal operations of the filled bottle, the filling valve is kept closed by the elastic membrane 6′ external to the enbloc body of the filling valve and it is actuated by a synchronized electro-valve 7.
